(19) United States
(12) Patent Application Publication
(10) Pub. No.: US 2025/0124101 A1
(43) Pub. Date: Apr. 17, 2025

(54) QUADRATIC UNCONSTRAINED BINARY OPTIMIZATION (QUBO) SOLVER ON GRAPHICS PROCESSING UNITS (GPUS)

(71) Applicant: Unisys Corporation, Blue Bell, PA (US)

(72) Inventors: Shruthi THURAVAKKATH, Bengaluru (IN); Salvatore SINNO, Leeds (GB); Antonio Dauphin FERNANDO, Bengaluru (IN)

(21) Appl. No.: 18/916,251

(22) Filed: Oct. 15, 2024

(30) Foreign Application Priority Data
Oct. 16, 2023 (IN) 202311070272

(51) Int. Cl. G06F 17/11

(52) U.S. Cl. CPC G06F 17/11

(57) ABSTRACT

Optimization problems, such as QUBO problems, can be solved using quantum or classical device. When solving using a classical device, GPUs are used to solve the problem. To optimize GPU usage and explore a deeper solution space, a genetic algorithm using an island model is used to generate an initial solution comprising bundles of close vectors and their associated energies. Simulated annealing is performed and initialized by the initial solution of the genetic algorithm. The simulated annealing process is combined with a student-teacher technique, in which teacher bundles are combined to form a student bundle that is subject to the simulated annealing process. The initialization of the simulated annealing processing using the initial solution from the genetic algorithm enhances the probability of identifying a solution close to the global minimum, while the student-teacher technique provides for deeper exploration of the solution space.

### CROSS-REFERENCE TO RELATED APPLICATIONS

This non-provisional patent application claims priority to Indian provisional patent application No. 202311070272, filed on Oct. 16, 2023, and titled “QUADRATIC UNCONSTRAINED BINARY OPTIMIZATION (QUBO) SOLVER ON GRAPHICS PROCESSING UNITS (GPUS),” the entire contents of which is incorporated by reference herein.

### BACKGROUND

Quadratic unconstrained binary optimization (QUBO) is a formulation used to represent combinatorial optimization problems in a way that is amenable to solution by quantum or classical algorithms. The coefficients of the quadratic function encapsulate the problem's constraints and objective details.

Graphics processing units (GPUs) are specialized electronic circuits designed to accelerate image rendering and processing in computing systems, although they have also been used for general-purpose computing tasks. Unlike central processing units (CPUs) that are designed for sequential processing, GPUs have a parallel architecture that includes thousands of smaller cores capable of handling multiple tasks simultaneously. This parallelism makes GPUs highly effective for computational tasks that can be performed in parallel, such as simulations and machine learning training.

### SUMMARY

Aspects of the technology described herein relate generally to systems for solving optimization problems using GPUs. To do so, for a given optimization problem, an initial solution is determined by a genetic algorithm. In an aspect, the genetic algorithm can employ an island model. In an aspect, the initial solution is provided to initialize a simulated annealing process. This combination helps increase the probability that the optimal solution, as determined by the simulated annealing process, is close to a global minimum, rather than stuck at a local minimum.

During the simulated annealing process, a student-teacher technique can be employed. Bundles of close vectors and their associated energies are determined by the genetic algorithm as part of the initial solution. As described herein, these bundles can act as teacher bundles and can be combined to form a student bundle, also referred to as a unified bundle or a unified student bundle. In an aspect, the student bundle is further explored using the simulated annealing. Using this technique, a solution from the exploration of the teacher and student bundles can be identified and provided as the optimal solution to the optimization problem.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology can be employed, in accordance with an aspect described herein;

FIG. 2 illustrates an example solution bundle generated using a genetic algorithm, in accordance with an aspect described herein;

FIG. 3 illustrates an example solution space, in accordance with an aspect described herein;

FIG. 4 illustrates a block diagram having an example in which teacher bundles are generated and explored, in accordance with an aspect described herein;

FIG. 5 illustrates a block diagram having an example in which a student bundle is generated and explored, in accordance with an aspect described herein;

FIG. 6 is a flow diagram illustrating an example initial solution process and an example optimal solution process, in accordance with an aspect described herein;

FIG. 7 is a flow diagram illustrating an example method for performing a genetic algorithm phase to generate an initial solution to an optimization problem, in accordance with an aspect described herein;

FIG. 8 is a flow diagram illustrating an example method for performing a simulated annealing phase to generate an optimal solution to an optimization problem, in accordance with an aspect described herein;

FIG. 9 is a flow diagram illustrating an example method for combining a genetic algorithm phase and a simulated annealing phase to generate a solution to an optimization problem, in accordance with an aspect described herein; and

FIG. 10 illustrates an example computing device that may implement aspects of the described technology, in accordance with an aspect described herein.

### DETAILED DESCRIPTION

Quadratic unconstrained binary optimization (QUBO) problems are a type of combinatorial optimization problem that can be formulated as a QUBO objective function. QUBO problems are often used to model real-world problems such as scheduling, routing, and knapsack problems.

QUBO problems can become exceptionally large and complex, especially in real-world applications such as optimization in machine learning, logistics, and financial modelling. Solving such problems using HPC (high performance computing) involves leveraging the parallel processing capabilities of HPC systems to explore a larger solution space in a shorter amount of time. This is particularly important because the search for the optimal binary configuration is an NP-hard problem, meaning that the time required to find an optimal solution grows exponentially with the problem size.

Parallel processing involves breaking down the optimization problem into smaller sub-problems that can be solved concurrently by different processing units. Techniques such as parallel tempering, simulated annealing, and hybrid optimization algorithms can be employed to explore the solution space efficiently. These methods utilize the vast computational resources provided by HPC to explore different configurations of binary variables and converge towards optimal or near-optimal solutions.

The technology described herein addresses the problem of using simulated annealing to solve QUBO on GPU. A Graphics Processing Unit (GPU) is a specialized computational hardware designed to efficiently handle multiple parallel operations for a broad range of computationally intensive tasks.

Simulated annealing is a probabilistic optimization algorithm that starts with a random solution and then iteratively moves to neighboring solutions, accepting moves that are more fit (e.g., are a better fit) and rejecting moves that are less fit (e.g., are a worse fit). However, simulated annealing can be trapped in local minima which are solutions that are not the global optimum but better than any of their neighboring solutions.

Poor initialization in a simulated annealing algorithm for QUBO problems can significantly impact the quality of the final solution. The algorithm's effectiveness relies on its ability to explore the solution space and escape local minima, which is influenced by the initial solution. If the initial solution is far from the optimal or high-quality regions of the solution space, it may lead the algorithm down a suboptimal path. Simulated annealing's success in finding good solutions depends on exploring different states and accepting worse solutions early in the process, which is hindered by a poor initial point. Therefore, selecting a well-informed initial solution or employing techniques like heuristics or problem-specific knowledge for initialization can enhance the chances of successful simulated annealing and discovering high-quality solutions in QUBO problems.

A good initialization can speed up the convergence process. Simulated annealing gradually reduces its willingness to accept worse solutions as it anneals (reduces temperature). If the initial solution is high quality, the algorithm can quickly exploit the neighborhood and focus on refining it. Conversely, a poor initialization might lead to prolonged exploration and slower convergence.

A well-chosen initial solution can help the algorithm avoid getting trapped in local minima. While simulated annealing is designed to escape local minima through its probabilistic nature, starting closer to a global minimum or a better region of the solution space improves the chances of quickly moving away from suboptimal solutions.

A genetic algorithm is a metaheuristic inspired by the process of natural selection that is used to find optimal or near-optimal solutions to a wide range of problems. A genetic algorithm works by iteratively generating a population of solutions, evaluating their fitness, and then using crossover and mutation operators to create new solutions.

A genetic algorithm explores a wide solution space and converges to potentially high-quality solutions. However, a genetic algorithm may not always find the exact optimal solution. Simulated annealing, on the other hand, can fine-tune solutions and navigate intricate solution landscapes but might require a well-initialized starting point to perform efficiently, as previously described.

Aspects of the technology integrate genetic algorithm as a preprocessing step can provide simulated annealing with a better starting solution, improving its chances of quickly converging to a high-quality solution.

To introduce diversity to the solution, the island model for genetic algorithms may be used. In general, the island model is a parallelization technique that can significantly improve diversity in the population of solutions during the optimization process. Diversity aids genetic algorithms because it helps prevent premature convergence to suboptimal solutions and promotes the exploration of the entire solution space.

In the island model, the population is divided into multiple subpopulations or “islands,” each of which operates independently. Each island runs its genetic algorithm iterations with its own set of individuals. A section algorithm specifies the criteria for the division.

The key idea is that different islands can explore different areas of the solution space, thereby introducing diversity. This is a stochastic process that over time converge to the optimal or near optimal solution.

As described above, simulated annealing can sometimes get stuck in local optima due to its probabilistic nature and temperature-based acceptance of worse solutions. Using tabu search, a “tabu list” can be maintained to restrict revisiting the same solutions, which can help diversify the search. The tabu list contains the list of solutions already explored. The tabu list controls the stochastic search space of new solution, preventing the algorithm from exploring areas with low fitness score.

Aspects of the technology described herein, combine tabu search to guide simulated annealing away from local optima when it gets trapped, providing more exploration capabilities.

To improve diversity, a teacher-student model is deployed where the knowledge gained by different “teachers” can be transferred to a student. This algorithm, an inter-genetic algorithm, which is a genetic algorithm applied between two solution bundles (teachers) on two different vectors, one from each teacher bundle. A new student bundle is built from the teacher bundles. Simulated annealing is then applied on the student bundle. This enhances the diversity, and the search space is expanded.

In an aspect of the technology, a combined approach to solving a QUBO problem, or more generally, another like optimization problem, combines a genetic algorithm with simulated annealing.

In an aspect, the genetic algorithm phase initializes a population of solutions, applies selection, crossover, and mutation operations, and evolves the population over several generations. This process aims to identify diverse potential solutions and refine them through evolution.

In an aspect, the best solution obtained from the genetic algorithm phase is then used as an initial solution for the simulated annealing algorithm. This solution will be near the optimal solution due to the exploration performed by the genetic algorithm.

During simulated annealing phase, the algorithm starts with the solution transferred from the genetic algorithm phase. It explores neighboring solutions and probabilistically accepts moves based on the acceptance criterion. The annealing schedule, controlling the decrease in exploration probability, aids in finding the optimal or near-optimal solution.

An advantage of this novel two-phase approach is that the genetic algorithm is well-suited for exploration and generating diverse solutions across the solution space. At the same time, simulated annealing excels at fine-tuning and refining solutions. Combining them can help efficiently search for reasonable initial solutions and then optimize them to find the global optimum or near-optimal solutions in complex optimization problems like QUBO.

Aspects of the present technology combine simulated annealing with genetic algorithm for QUBO solving on GPU. By adopting this methodology the diversity of the search is enhanced and the horizon of exploration is expanded in pursuit of optimal solutions within the QUBO problem domain. This interplay between teacher and student bundles adds a layer of sophistication to the approach that leads to a more robust and comprehensive search process that capitalizes on the strengths of both genetic algorithms and simulated annealing. Use of the technology has provided a faster convergence, and deeper exploration and diversification, leading to improved solution quality compared to existing methods.

It will be realized that the methods previously described are only examples that can be practiced from the description that follows, and they are provided to more easily understand the technology and recognize its benefits. Additional examples are now described with reference to the figures.

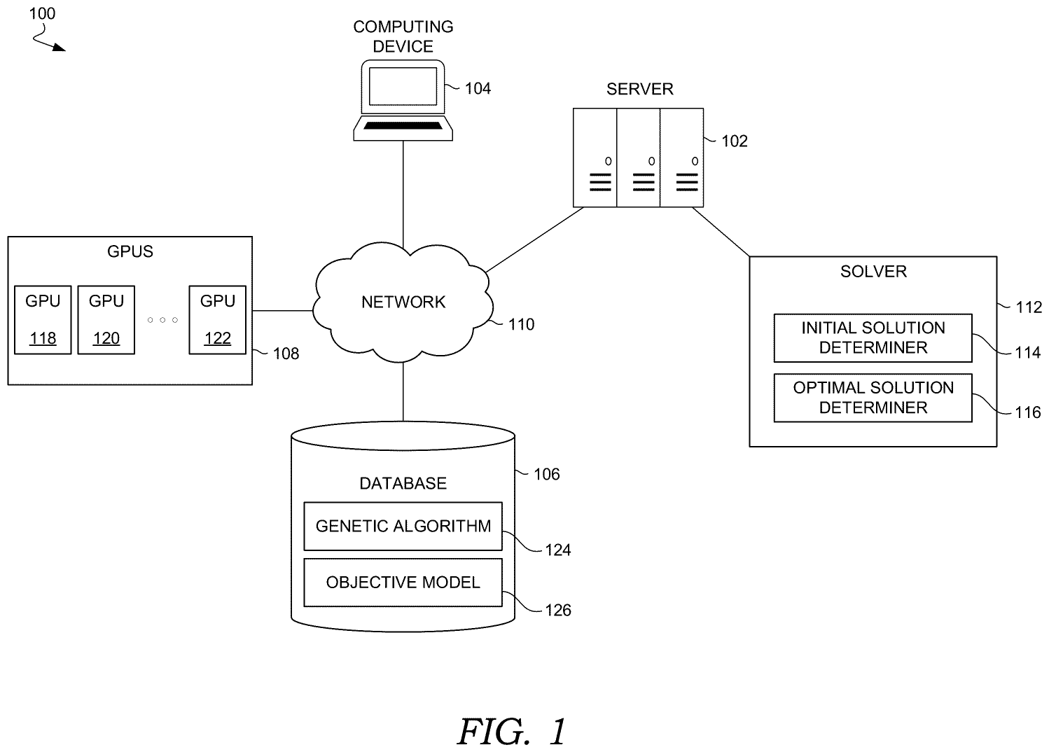

With reference now to FIG. 1, an example operating environment 100 in which aspects of the technology may be employed is provided. Among other components or engines not shown, operating environment 100 comprises server 102, computing device 104, database 106, and GPUs 108, which are communicating via network 110. In an aspect, server 102 performs solver 112.

In an aspect, database 106 stores information, including data, computer instructions (e.g., software program instructions, routines, or services), or models used in embodiments of the described technologies. Although depicted as a single database component, database 106 may be embodied as one or more databases or may be in the cloud. In some aspects, database 106 is representative of a distributed ledger network (e.g., a system where data as replicated, shared, and synchronized over a plurality of locations that may be geographically distinct).

In an aspect, the components illustrated in block diagram 100 communicate via network 110. In an aspect, network 110 includes one or more networks (e.g., public network or virtual private network [VPN]). Network 110 may include, without limitation, one or more local area networks (LANs), wide area networks (WANs), or any other communication network or method. Such networking environments are commonplace in offices, enterprise-wide computer networks, intranets, and the internet. It should be understood that any number of user devices and servers (e.g., computing device 104 and/or server 102) may be employed within the system illustrated in block diagram 100 within the scope of the present technology. Each device or server may comprise a single device or multiple devices cooperating in a distributed environment. For instance, the solver 112 could be provided by multiple server devices (e.g., a plurality of server 102 components) collectively providing the functionality of the solver 112, as described herein. Additionally, other components not shown may also be included within the network environment.

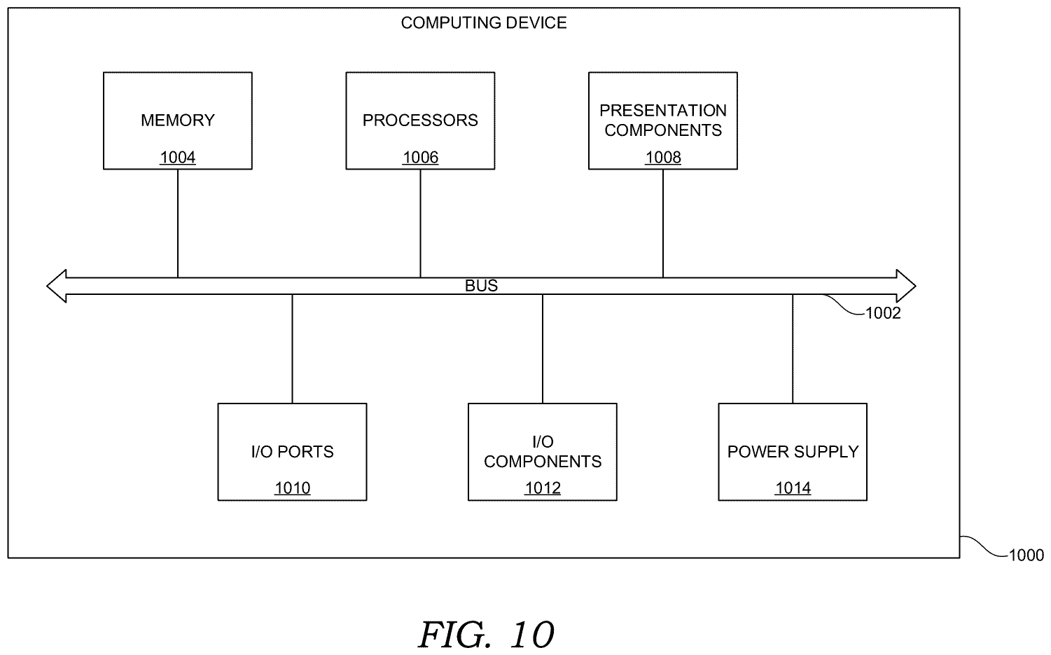

Generally, server 102 is a computing device that implements functional aspects of operating environment 100, such as one or more functions solver 112 to generation a solution to an optimization problem using GPUs. One suitable example of a computing device that can be employed as server 102 is described as computing device 1000 with respect to FIG. 10. In implementations, server 102 represents a back-end or server-side device. In an aspect, the example operating environment 100 can comprise server-side software (e.g., executing on server 102) that is designed to work in conjunction with client-side software (e.g., on computing device 104) so as to implement any combination of the features and functionalities discussed in the present disclosure. For example, the computing device 104 can include an application (not shown in FIG. 1) for interacting with the server 102 (including the solver 112), the GPUs 108, and/or the database 106). This application can be, for instance, a web browser or a dedicated application for providing functions, such as those described herein. This division of an operating environment illustrated in block diagram 100 is provided to illustrate one example of a suitable environment. There is no requirement for each implementation that any combination of the computing device 104 and the rest of the entities of block diagram 100 remain as separate entities. For example, while the operating environment illustrated in block diagram 100 illustrates a configuration in a networked environment with a separate computing device, it should be understood that other configurations can be employed in which aspects of the various components are combined. For instance, in some aspects, aspects of the various entities can be implemented in part or in whole by the computing device 104.

Computing device 104 is generally a computing device that may be used to interface with server 102 for facilitating problem optimization problem solving on GPUs. In an aspect, computing device 104 is used to provide an optimization problem. In some examples, computing device 104 can provide or otherwise generate an optimization model, such as one taking QUBO form, and one or more constraints for the optimization model for solving by GPUs 108. In an aspect, the computing device 104 may comprise any type of computing device capable of use by a user. For example, in one aspect, computing device 104 may be a computing device such as the computing device 1000 described in relation to FIG. 10 herein. By way of example and not limitation, the computing device 104 may be embodied as a personal computer (PC), a laptop computer, a mobile or mobile device, a smartphone, a tablet computer, a smart watch, a wearable computer, a personal digital assistant (PDA), an MP3 player, a satellite positioning system, (e.g., a global positioning system) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the computing device 104 and may interact with the other entities of the example operating environment 100 described in FIG. 1 (e.g., the GPUs 108, the database 106, the server 102, and/or the solver 112).

As with other components of FIG. 1, computing device 104 is intended to represent one or more computing devices. In implementations, computing device 104 is a client-side or front-end device. While the example architecture illustrated in FIG. 1 illustrates functions of solver 112 being performed by server 102, it will be understood that this is just one example, and there may be more or fewer functions of solver 112, which may be employed in various orders. It is further noted that, in some implementations of the technology, functions of solver 112 may be performed by other components of FIG. 1, or by components not shown. As an example, in some implementations, computing device 104 may be used to perform functions of solver 112 in lieu of or in combination with server 102. The illustrated drawing is but one example used to aid in describing an aspect of the technology.

GPUs 108 generally comprise specialized hardware for performing parallel processing operations. In some aspects, GPUs can be operated locally on a device, such as computing device 104, where they are installed as dedicated hardware components. This local deployment facilitates direct access to the GPU resources, providing low-latency processing by performing tasks locally without external communications. In some aspects, GPUs can be hosted on disparate devices within a network, enabling remote access and utilization of GPU resources. This setup allows multiple devices to share the computational power of a single or multiple GPUs, thereby enabling distributed computing scenarios. In another aspect, GPU resources can be accessed within a cloud-based architecture, where GPUs are hosted on cloud servers and are made accessible over the internet. Combinations of these architectures may also be used for GPU processing. Thus, in some examples, GPUs 108 may be executed using server 102, computing device 104, or within a cloud architecture, or any combination thereof. As illustrated using GPU 118, GPU 120, and GPU 122, any number of GPUs may be included within GPUs 108. GPUs may be included as part of or otherwise executed using a computing device, such as 1000 of FIG. 10.

In general, solver 112 can be used to solve optimization problems, such as a formulated QUBO problem or other optimization problem, using GPUs 108. To do so, the example solver 112 illustrated in FIG. 1 employs initial solution determiner 114 and optimal solution determiner 116.

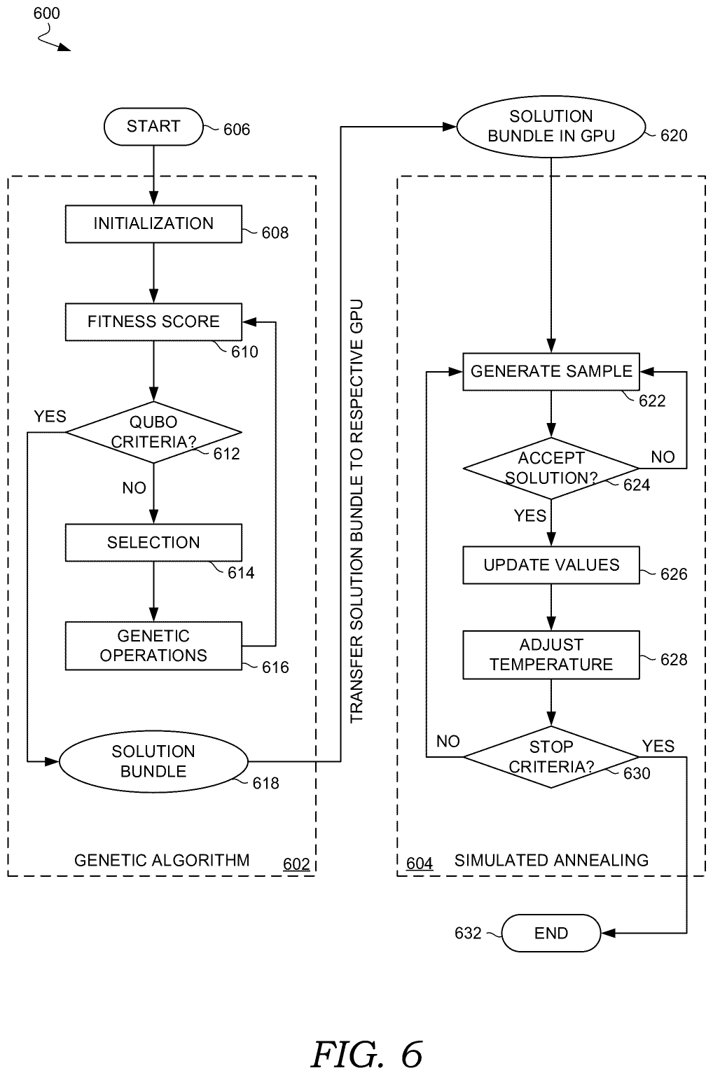

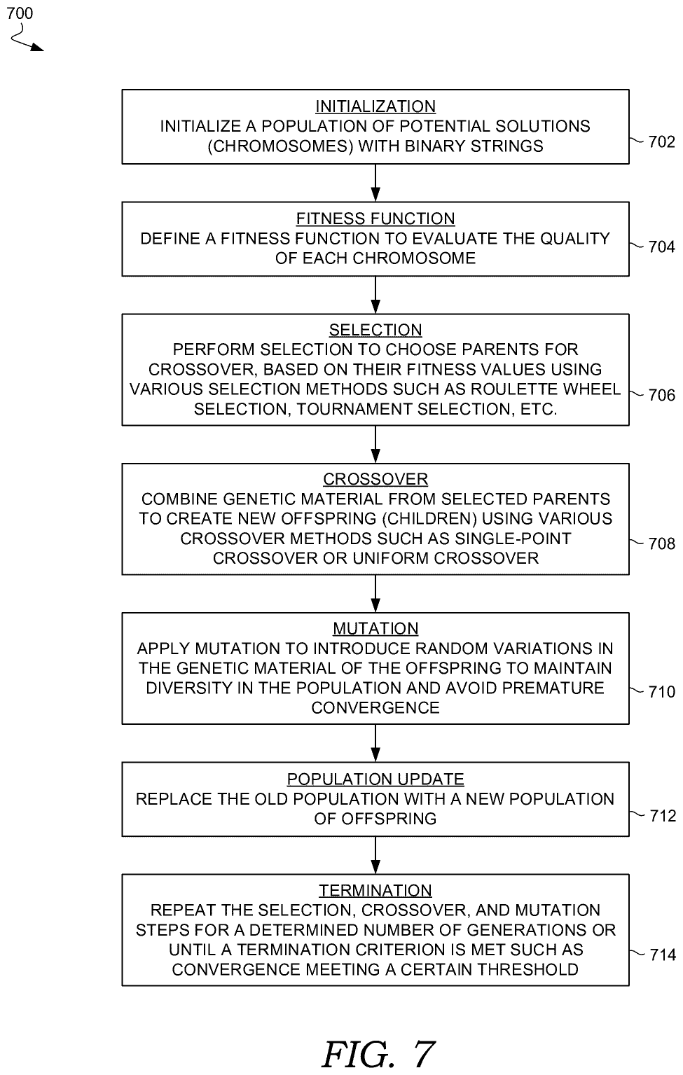

In an aspect, initial solution determiner 114 is used to generate an initial solution that can be consumed by optimal solution determiner 116 to determine an optimal solution to an optimization problem. In an aspect, initial solution determiner 114 employs genetic algorithm 124 to determine the initial solution from a population of potential solutions for the optimization problem. In an aspect, initial solution determiner 114 implements the initial solution process of the genetic algorithm 602 illustrated in FIG. 6 to determine the initial solution. In some aspects, initial solution determiner 114 may determine the initial solution by performing aspects of the process described in flow diagram 700, illustrated in FIG. 7.

In an aspect, initial solution determiner 114 receives an optimization problem and generates an initial solution using a genetic algorithm, as described herein. In an aspect, initial solution determiner 114, in conjunction with optimal solution determiner 116 (described below), generates a solution to the optimization problem using systems and methods described herein. For example, initial solution determiner 114 may initialize a population of possible solutions using binary strings, define a fitness function to evaluate a proposed initial solution, perform selection to choose appropriate candidates for the genetic algorithm crossover, combine the material from selected parents using crossover to produce new offspring, apply randomness to the offspring (e.g., mutation), and update the population. In an aspect, initial solution determiner 114 continues the selection, crossover, and mutation steps for either a determined number of generation or until a convergence criterion is met. In an aspect, initial solution determiner 114 provides the result of these operations as an initial solution that can be used by optimal solution determiner 116 as a starting point for a simulated annealing algorithm.

One example of genetic algorithm 124 incorporates five genetic operations: mutation, crossover, zero, one, and random. As used herein, “crossover” is a genetic operation that combines genetic material from two parent solutions to create one or more offspring, often involving swapping sections of their genetic information. As used herein, “mutation” is a genetic operation that introduces random changes to individual elements in a solution to promote diversity and exploration of the solution space. As used herein, “zero” is a genetic operation that sets one or more elements in a solution to zero, potentially altering the solution's characteristics or feasibility. As used herein, “one” is a genetic operation that sets one or more elements in a solution to one, potentially altering the solution's characteristics or feasibility. As used herein, “random” is a genetic operation that introduces random variations to elements in a solution, contributing to diversity in the population.

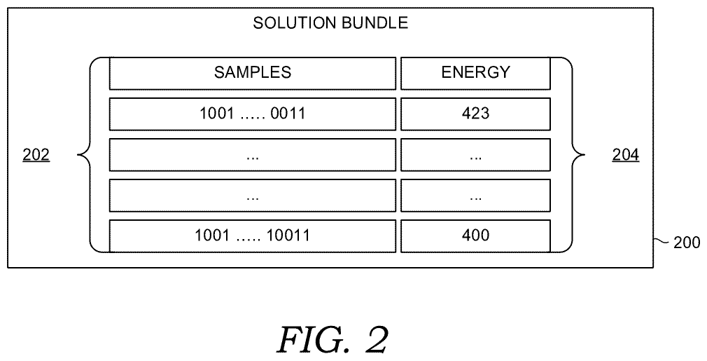

In an aspect, an island model is used for genetic algorithm 124. As described herein, an island model involves deploying multiple solution bundles, with each bundle comprising a set of n samples generated through the genetic operations. This allows population of the solution bundles. In an aspect, each row in a solution bundle can represent a sample vector along with its energy. FIG. 2, described below, illustrates an example solution bundle 200 determined using genetic algorithm 124 and comprising variable vectors 202 and energy levels 204 corresponding to each variable vector of variable vectors 202.

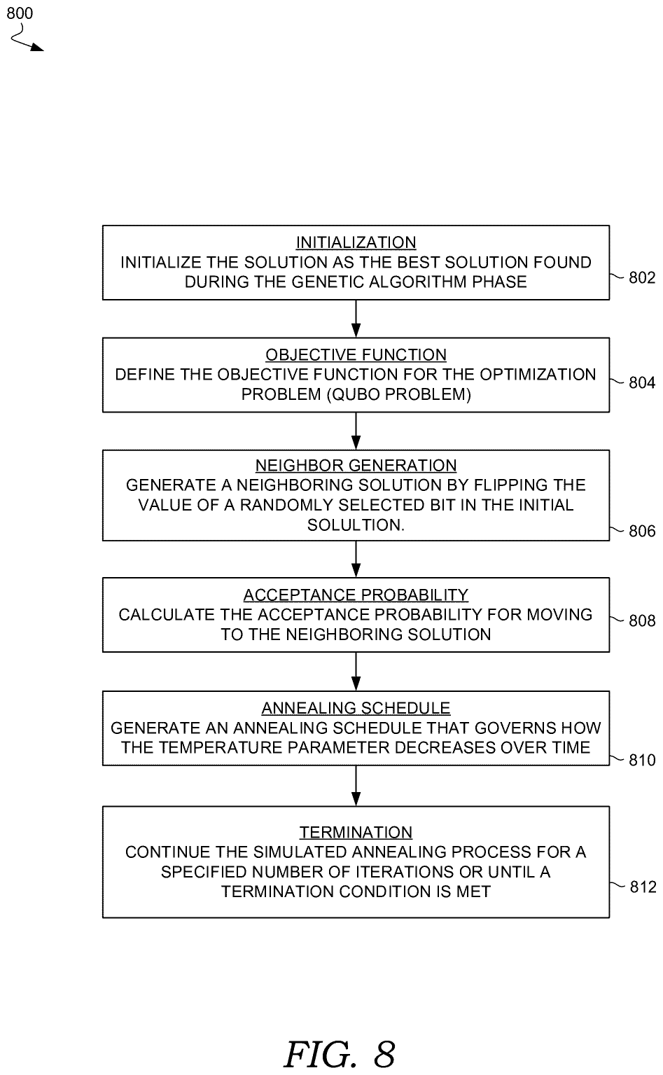

In an aspect, optimal solution determiner 116 determines an optimal solution to the optimization problem and does so using the initial solution determined from the genetic algorithm 124 by initial solution determiner 114. In an aspect, optimal solution determiner 116 determines an optimal solution to the optimization problem by performing a simulated annealing process on objective model 126 using GPUs 108. In an aspect, optimal solution determiner 116 implements the optimized solution process using simulated annealing 604 illustrated in FIG. 6 to determine the optimal solution. In some aspects, optimal solution determiner 116 determines the optimal solution using aspects of the process of flow diagram 800 illustrated in FIG. 8.

In an aspect, optimal solution determiner 116 receives the initial solution to an optimization problem from initial solution determiner 114 (described above) and generates an optimal solution using simulated annealing, as described herein. In an aspect, optimal solution determiner 116, in conjunction with initial solution determiner 114, generates a solution to the optimization problem using systems and methods described herein. For example, optimal solution generator 116 may receive an initial solution from initial solution determiner 114, generate an objective function for a QUBO problem, generate a neighboring solution (to the initial solution) using bit flipping, calculate the probability for moving to the neighboring solution, generate an annealing schedule, perform simulated annealing on the neighboring solution, and continue generating the neighboring solution, calculating the probability, and performing the annealing, until either a determined number of iterations or a termination criteria is met. In an aspect, optimal solution determiner then provides the result of these operations as an optimal solution to the optimization problem.

In an aspect, a simulated annealing algorithm can use one or more of two flipping operations, described herein as “single flip” and “multi flip” operations. In some aspects, when employing the multi-flip variant, a simulated annealing algorithm selects one or more bits from a variable vector and flips them. In some aspect, when employing the single-flip variant, a simulated annealing algorithm selects a single bit of the variable vector and flips that single bit. The simulate annealing algorithm can be configured to explore the solution space by iteratively moving to neighboring solutions as will be described, accepting solutions that improve the objective according to objective model 126.

In an aspect, optimal solution determiner 116 allocates individual solution bundles to corresponding GPUs (e.g., of GPUs 108). In an aspect, the simulated annealing process performed by optimal solution determiner 116 incorporates a “tabu” search technique into both instances of the simulated annealing algorithms. A tabu search is an optimization technique that uses a local search technique to avoid getting stuck in local optimal solutions (e.g., local minima). In tabu search, a tabu period denoted as “t” is defined. When a bit is flipped, it becomes forbidden (e.g., tabu) to flip that same bit again in the subsequent iterations. After n iterations, as defined by the algorithm, the bit is once again eligible for flipping. The tabu search technique helps prevent the entrapment of the algorithm in a specific local minimum solution, thus promoting effective exploration of the solution space. In an aspect, the sample vectors can be updated within the solution space with the solutions derived from simulated annealing when their energy levels are lower than those of the initial sample vectors. Having performed this operation for all vectors within each solution bundle, across all solution bundles, the result provides updated bundles where all vectors within each bundle share a relatively close relationship, given their common genetic origins, having initially been generated through common genetic operations.

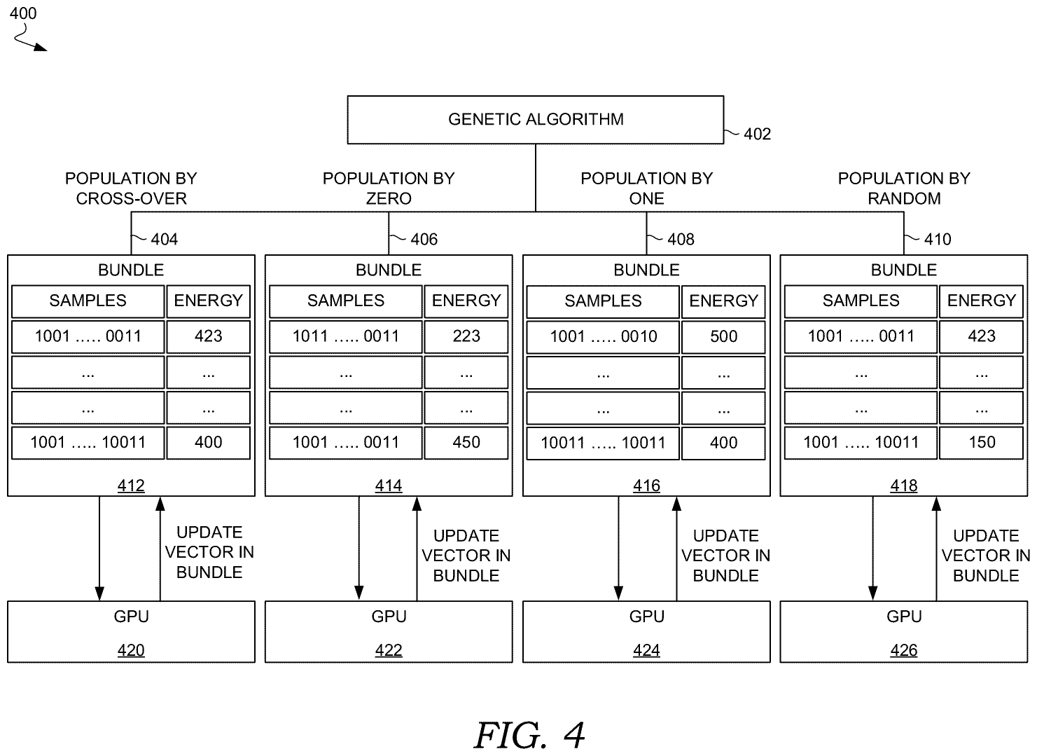

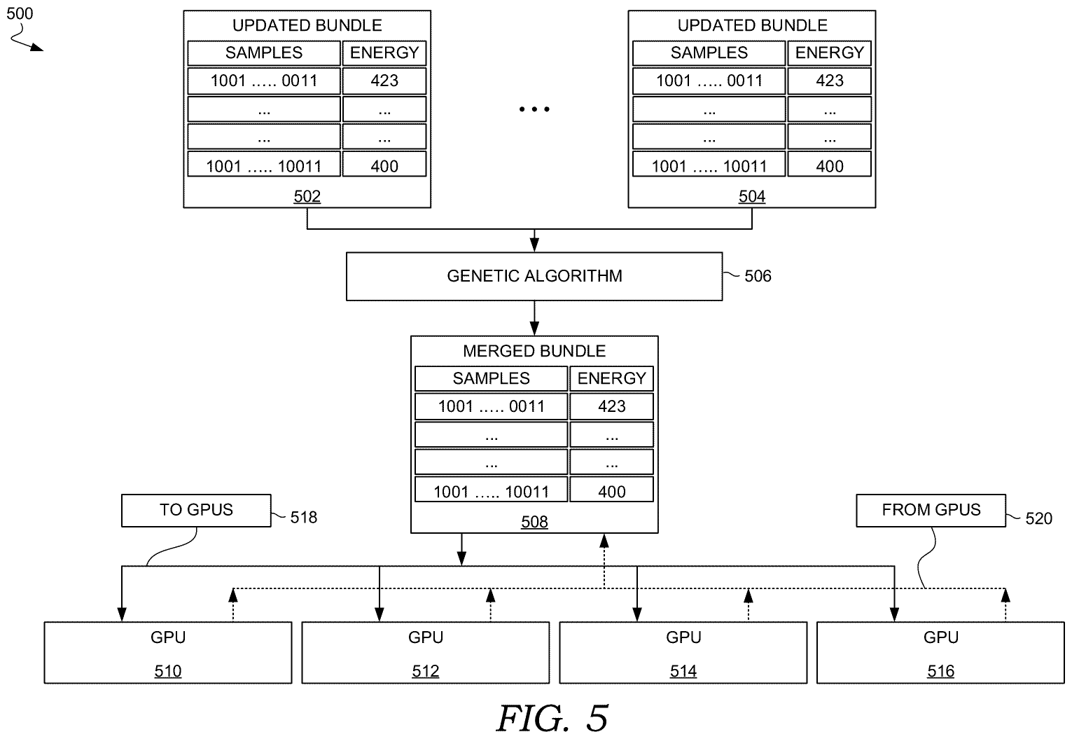

In an aspect, to thoroughly investigate the solution space located between these distinct solution bundles, a teacher-student technique is employed. FIG. 4 and FIG. 5, described below, illustrate this teacher-student technique as applied to the current technology. This approach enables exploration of the solution space beyond the boundaries set by the individual teacher bundles. This approach also enables the exploration into solutions between these teacher bundles thus providing the potential to generate more optimal solutions.

FIG. 2 illustrates an example solution bundle 200 generated using a genetic algorithm, in accordance with an aspect described herein. The solution bundle 200 illustrated in FIG. 2 comprises variable vectors with samples 202 and corresponding energy levels 204. When using the island model for the genetic algorithm (e.g., genetic algorithm 124), each solution bundle comprises a set of n samples generated using the five genetic operations described above (e.g., “mutation,” “crossover,” “zero,” “one,” and “random”). In an aspect, this utilization of a genetic algorithm populates a solution bundle where each row of a solution bundle represents a sample vector and a corresponding energy. For example, a first variable vector sample (a binary variable vector) is “1001 . . . 0011” which is an i bit binary number (e.g., a binary number with i bits) and a second variable vector sample is “1001 . . . 10011” which is also an i bit binary number. In this example, first variable vector sample “1001 . . . 0011” has energy level 423 and second variable vector sample “1001 . . . 10011” has energy level 400. In an aspect, the bits of the sample vectors are randomly generated. In an aspect, the sample vectors are also referred to as chromosomes, when used as data elements of a genetic algorithm, as described herein. In an aspect, an energy level of a variable vector sample represents an energy value for the chromosome, which is used by the simulated annealing algorithm. In an aspect, a simulated annealing algorithm uses energy levels to determine whether to update the sample vectors within the solution space with the solutions derived from simulated annealing if the energy levels of the new solutions (e.g., the new vectors) have lower energy levels than the energy levels of the initial solution vectors. In an aspect, a solution vector with a lower energy level is more fit (e.g., is a better solution).

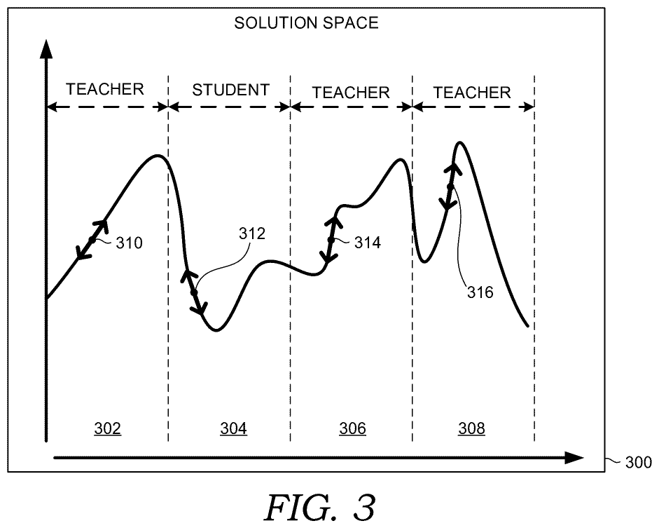

FIG. 3 illustrates an example solution space 300, in accordance with an aspect described herein. FIG. 3 illustrates a graphical example of a solution space (e.g., comprised of several solution bundles), with potential solutions identified in teacher domains and student domains. In this example, the global minimum exists in student domain 304 and there are local minima in teacher domain 314 and teacher domain 316. Starting with an initial solution at location 310 in teacher domain 302, a local minimum would not be found. Starting with an initial solution at location 312 in student domain 304, a local minimum, which is also the global minimum, would be found. Starting at location 314 in teacher domain 306, a local minimum (and possibly two, between the two peaks) would be found. Starting at location 316 in teacher domain 308, a local minimum would be found. Using these three (or four) possible solutions, the global minimum in student domain 304 could be found using the techniques described herein.

In an aspect, individual solution bundles (e.g., teacher bundle 302, student bundle 304, teacher bundle 306, and teacher bundle 308) are allocated to individual GPUs 108. In some aspects, the tabu search technique then uses these bundles and employs one or both instances of the simulated annealing algorithms described above. As described above, a tabu search technique prevents the entrapment of the algorithm in a local minimum solution (e.g., in teacher bundle 306 or teacher bundle 308), thus enabling exploration of the entire solution space. As described below, the sample vectors within the solution space are updated with the solutions derived from simulated annealing if their energy levels are lower than those of the initial sample vectors. By performing this operation for all vectors within each solution bundle (e.g., teacher bundle 302, student bundle 304, teacher bundle 306, teacher bundle 308, etc.), across all solution bundles of solution space 300, updated bundles are generated where all vectors within each bundle share close relationships, given their common genetic origins, having initially been generated through common genetic operations. This updating is described below in connection with FIG. 4 and FIG. 5.

FIG. 4 illustrates a block diagram having an example in which teacher bundles are generated and explored, in accordance with an aspect described herein. As illustrated in FIG. 4, an optimal solution determiner such as optimal solution determiner 116 receives output of a genetic algorithm 402, which is a genetic algorithm such as genetic algorithm 124, described above. In the example illustrated in FIG. 4, a first bundle 412 is populated by “crossover” 404, a second bundle 414 is populated by “zero” 406, a third bundle 416 is populated by “one” 408, and a fourth bundle 418 is populated by “random” 410. In some aspects, not shown in FIG. 4, a fifth bundle is populated by “mutation,” as described above. In an aspect, each of the bundles is provided to a GPU (e.g., one of GPUs 108) so that, for example, bundle 412 is provided to GPU 420, bundle 414 is provided to GPU 422, bundle 416 is provided to GPU 424, and bundle 418 is provided to GPU 426. In an aspect, each GPU performs operations to update the bundles using simulated annealing on the GPU. In an aspect, these updated bundles (or evolved bundles) are provided as teachers to be merged into a unified bundle (e.g., a unified student bundle), as described in connection with FIG. 5. In an aspect, this unified student bundle can be used for further exploration of the solution space using the simulated annealing algorithms.

The technology described herein provides advancements in the operation of computing systems by optimizing algorithms for solving optimization problems using parallel processing on a GPU. This maximizes the computational efficiency of the computer by improving the utilization of the GPUs. In an aspect, the GPUs (e.g., GPUs 108) ingest the problem and generate results using fewer computational processes than the hardware would otherwise require to arrive at a solution. For example, an optimization problem can be combinatorial in nature, where the solution space increases exponentially in as inputs and constraints increase. Solution discovery for these problem types rapidly outpaces the computational power of a GPU, as each GPU has a limited number of threads with which to process potential solutions. Accordingly, the process of finding a solution to these problem directly impacts the hardware performance of the GPUs as they become oversaturated. As the problem becomes more complex, the GPUs must work harder to find an optimal solution. To explore more of the solution space, one can add additional GPUs, thereby adding more hardware components that can process the space, or provide the existing GPUs with more time to perform additional operations. However, this is limited to the attainable hardware. However, some of the aspects described herein provide for additional exploration of the solution space (e.g., exploring a student bundle, and initializing the simulated annealing with the output of the genetic algorithm) without increasing the GPU hardware. As such, some of the processes and model described herein increase the efficiency with which GPUs can be employed, resulting in the less computationally intensive discovery of an optimal solution to the problem.

In some aspects, both the simulated annealing algorithm and the genetic algorithm use random numbers. For random number generation on the GPU, the host computer can generate random seeds using a Mersenne twister (a general-purpose pseudorandom number generator [PRNG] that has a long period and that is based on a Mersenne prime) and transfer them to the threads of the GPUs through the global memory such that each thread has, for example, a 64-bit random seed. In some aspects, each thread may perform Xor (exclusive or) shift to quickly generate new random numbers from the seed.

For example, the execution of solver 112 for a generated random solution X can be termed a “run.” Since GPUs have many cores, solver 112 can run for distinct random n-bit vector X in parallel so that multiple runs are performed concurrently, and an optimal solution in all runs can be selected.

As an example GPU architecture, the A100 GPU architecture is equipped with 108 streaming multiprocessors. Each streaming multiprocessor can host 2048 resident threads dispatched to 64 cores for execution. Consequently, an A100 GPU can concurrently accommodate 221,184 resident threads executing on its 6912 cores.

In this example, each streaming multiprocessor features a 164 KB shared memory accessible to threads within the same multiprocessor. Additionally, each offers 64K 32-bit registers that can be allocated to resident threads. Thus, with 2048 resident threads loaded, each thread can access up to 32 32-bit registers. Furthermore, the A100 GPU has 40 GB of global memory accessible to all threads.

The A100 GPU is one example suitable for use as GPUs 108 and for use by solver 112. In this example setup, the program running on a host system dispatches a compute unified device architecture (CUDA) kernel comprising multiple CUDA blocks organized within a GPU's streaming multiprocessors. Each CUDA block can accommodate a maximum of 1024 threads, all operating as resident threads within the same streaming multiprocessor. To illustrate, if each CUDA block consists of 1024 threads, each streaming multiprocessor can handle up to 2 concurrent CUDA blocks. Given that an A100 GPU has 108 streaming multiprocessors, 216 CUDA blocks can be loaded simultaneously for execution on a single GPU. With 2 A100 GPUs, the collective capacity allow a total of (216×2) 432 CUDA blocks to be loaded for execution. With each CUDA block assigned to perform a single run, this configuration enables simultaneously carrying out 432 runs by harnessing the power of 2 GPUs. QUBO instance has 2048 bits; a CUDA block with 1024 threads is used such that each thread works for updating two bits. In an example, a CUDA program for GPU implementation of a single-flip algorithm performs one CUDA kernel call with 216 CUDA blocks with 1024 threads each to perform 216 runs.

In an aspect, a large QUBO model can be divided into subsets, for example, 9 subsets with 128 bits each, and each CUDA block works on a subset. In an aspect, if each subset has 128 bits, CUDA blocks with 128 threads each can be used. Notably, if an A100 GPU has 108 streaming multiprocessors with 2048 resident threads each, 1728 ((108×2048)/128) CUDA blocks can be dispatched, allowing 192 runs can be performed in parallel.

FIG. 5 is a block diagram illustrating an example in which a student bundle is generated and explored, in accordance with an aspect described herein. In an aspect, updated bundle 502 is a bundle such as bundle 404 that has been updated by GPU 420 and updated bundle 504 is a bundle such as bundle 418 that has been updated by GPU 426, as described above in connection with FIG. 4. In the example illustrated in FIG. 5, updated bundles corresponding to bundle 414 and bundle 416 are omitted for clarity and represented by the three dots between updated bundle 502 and updated bundle 504. In an aspect, a genetic algorithm 506 is used to combine updated bundle 502, updated bundle 504 (and other updated bundles) to generate a merged bundle 508. As described above in connection with FIG. 4, each GPU of GPU 420, GPU 422, GPU 424, and GPU 426 performs operations to update the bundles using simulated annealing on the GPU to generate updated bundle 502 and updated bundle 504 (and others). In an aspect, these updated bundles are provided as teachers (also referred to herein as teacher bundles) to be merged into a merged bundle 508 (also referred to herein as a unified bundle or a unified student bundle). In an aspect, this unified student bundle can be used for further exploration of the solution space using the simulated annealing algorithms.

In an aspect, after merged bundle 508 is generated by genetic algorithm 506, merged bundle 508 is provided 518 to GPU 510, GPU 512, GPU 514, and GPU 516 so it can be distributed across the GPUs. In an aspect, this distribution reduces computational time and improves efficiency of the simulated annealing operation (e.g., performed on the merged bundle 508). In an aspect, the result of the distributed simulated annealing operation is received 520 from the GPUs and merged bundle 508 is updated to the improved solution (not shown in FIG. 5). In an aspect, when the simulated annealing operation successfully identifies an improved solution, a procedure to iteratively update the solution bundles is followed (e.g., to generate additional teacher bundles from the merged and updated student bundle, merged bundle 508). In an aspect, this iterative approach provides for the continuous expansion of the search bundles and promotes the attainment of diversity within the optimization process. FIG. 5 illustrates an example in which teacher bundles (labeled as “updated bundles”) are merged into a student bundle (labeled as “merged bundle”), and this bundle (and the corresponding location with the solution space) is explored using simulated annealing performed by GPUs. In an aspect, using the updated unified bundle (e.g., the updated merged bundle 508), an optimal solution out of all the bundles (e.g., the teacher and student bundles) can be identified and output as the optimal solution.

FIG. 6 is a flow diagram 600 illustrating an example initial solution process and an example optimal solution process, in accordance with an aspect described herein. In an aspect, FIG. 6 illustrates a process or method that can be implemented to find an optimal solution to an optimization problem. The method illustrated in FIG. 6 comprises an initial solution process using a genetic algorithm 602, which can be performed by an initial solution determiner such as initial solution determiner 114 to generate an initial solution comprising one or more solution bundles. The method illustrated in FIG. 6 comprises an optimized solution process using simulated annealing 604, which can be performed by an optimal solution determiner such as optimal solution determiner 116 to determine an optimal solution, having been initialized with the initial solution from initial solution process using genetic algorithm 602.

Each step the process illustrated in flow diagram 600 can comprise a computing process performed using any combination of hardware, firmware, or software. For instance, various functions can be carried out by a processor executing instructions stored in memory. The process illustrated in flow diagram 600 can also be embodied as computer-usable instructions stored on computer storage media. The process illustrated in flow diagram 600 can be provided by a standalone application, a service or hosted service (standalone or in combination with another hosted service), or a plug-in to another product, to name a few possibilities. The process illustrated in flow diagram 600 can be implemented in whole or in part by components of operating environment 100, such as initial solution determiner 114 and/or optimal solution determiner 116 of solver 112, among other components or functions not illustrated.

The process illustrated in flow diagram 600 starts 606 and begins performing initial solution process using genetic algorithm 602. In an aspect, initial solution process using genetic algorithm 602 is performed by a processor of server 102 that performs aspects of initial solution determiner 114.

In an aspect, at step 608 of initial solution process using genetic algorithm 602, a processor performing initial solution determiner 114 performs operations to initialize a population of potential solutions. In an aspect, the operations to initialize a population of potential solutions comprises generating a population of binary vectors that represent chromosomes usable by initial solution process using genetic algorithm 602 to generate an initial solution. In an aspect, these binary vectors are defined by equation (1), described below. For example, at step 608, the population of potential solutions may include binary vectors comprising random or pseudorandom bits, as described above at least in connection with FIG. 2. In an aspect, this population of potential solutions are combined into a solution bundle such as solution bundle 200. In an aspect, this population of potential solutions may be referred to as samples or chromosomes. In an aspect, after step 608, initial solution process using genetic algorithm 602 continues at step 610.

In an aspect, at step 610 of initial solution process using genetic algorithm 602, a processor performing initial solution determiner 114 performs operations to generate a fitness score for each bundle of the initial population generated at step 608. In an aspect, this fitness score is based on a fitness function such as equation (2), described below. In an aspect, after step 610, initial solution process using genetic algorithm 602 continues at step 612.

In an aspect, at step 612 of initial solution process using genetic algorithm 602, a processor performing initial solution determiner 114 performs operations to determine whether the fitness score generated at step 610 meets a QUBO criteria, as described in connection with FIG. 8 and equation (3) below. In an aspect, at step 612, if it is determined that the fitness score generated at step 610 meets a QUBO criteria (“YES” branch) initial solution process using genetic algorithm 602 continues at step 618. In an aspect, at step 612, if it is determined that the fitness score generated at step 610 does not meet a QUBO criteria (“NO” branch) initial solution process using genetic algorithm 602 continues at step 614.

In an aspect, at step 614 of initial solution process using genetic algorithm 602, a processor performing initial solution determiner 114 performs operations to perform selection to choose parents for crossover, based on the fitness value determined at step 610. In an aspect, operations to perform selection to choose parents for crossover are performed using roulette wheel selection. As used herein, roulette wheel selection is a selection method where individuals from the population are chosen based on their fitness, where an individual with a higher fitness has a larger “slice” of a metaphorical roulette wheel so that the more fit individuals have a higher probability of being randomly selected (e.g., when the metaphorical wheel is spun) as parents for crossover. In an aspect, operations to perform selection to choose parents for crossover are performed using tournament selection. As used herein, tournament selection is a selection method where individuals from the population are chosen based on their fitness, where randomly selected individuals are paired off in a metaphorical tournament and the winner of the pairing (the individual with the with a higher fitness level) advances to the next round and the winner of the tournament is selected as a parent for crossover. In tournament selection, a smaller tournament size tends to allow a less fit individual to be selected for crossover because a larger tournament size increases the probability that the less fit individual will meet a more fit individual in one of the tournament rounds. In an aspect, after step 614, initial solution process using genetic algorithm 602 continues at step 616.

In an aspect, at step 618 of initial solution process using genetic algorithm 602, a processor performing initial solution determiner 114 performs one or more genetic operations such as crossover (to combine genetic material from the parents selected at step 616) and mutation (to apply random variations to the parents selected at step 616 to maintain diversity of the population) to generate children, both described below in connection with FIG. 7. In an aspect, the children generated from these genetic operations replace the parents selected at step 614. In an aspect, after step 618, initial solution process using genetic algorithm 602 continues at step 610 algorithm 602, a processor performing initial solution determiner 114 performs operations to generate a fitness score for the child bundles of the new population updated at step 618.

In an aspect, at step 618 of initial solution process using genetic algorithm 602, a processor performing initial solution determiner 114 performs operations to produce a solution bundle from the solution that meets the QUBO criteria, determined at step 612. In an aspect, the solution bundle is one of a plurality of solution bundles (e.g., updated bundles described in connection with FIG. 5) that are provided to GPUs at step 620, described below. In an aspect, after step 618, initial solution process using genetic algorithm 602 continues at step 620. In an aspect, not shown in FIG. 6, after step 618, initial solution process using genetic algorithm 602 continues at step 608 with a new initialization of a population of potential solutions.

In an aspect, at step 620, a processor performs operations to distribute the solution bundle generated at step 618 to one or more GPUs (e.g., GPUs 108). In an aspect, the operations to distribute the solution bundle generated at step 618 to one or more GPUs are performed by a processor of server 102. In an aspect, the operations to distribute the solution bundle generated at step 618 to one or more GPUs are performed by initial solution determiner 114. In an aspect, the operations to distribute the solution bundle generated at step 618 to one or more GPUs are performed by optimal solution determiner 116. In an aspect, the operations to distribute the solution bundle generated at step 618 to one or more GPUs are performed by another component of solver 112, not shown in FIG. 1. In an aspect, after step 620, optimized solution process using simulated annealing 604 begins at step 622.

In an aspect, operations of optimal solution process using simulated annealing 604 are performed by a processor of server 102 that performs aspects of optimal solution determiner 116. In an aspect, at step 622 of optimized solution process using simulated annealing 604, a processor performing optimal solution determiner 116 performs operations to generate a sample. In an aspect, at the first iteration of optimal solution process using simulated annealing 604, the sample generated at step 622 is derived from the solution bundle provided to the GPUs at step 620. In an aspect, at subsequent iterations of optimal solution process using simulated annealing 604, the sample generated at step 622 is derived from the current bundle, as altered by iterations of optimal solution process using simulated annealing 604. In an aspect, the sample generated at step 622 is generated by defining an objective function, generating a neighboring solution by bit-flipping, and calculating the acceptance probability for moving to the neighboring solutions, as described below with respect to step 804, step 806, and step 808 of the flow diagram 800 using equation (3) and equation (4), all described herein at least in connection with FIG. 8. In an aspect, after step 622, optimized solution process using simulated annealing 604 continues at step 624.

In an aspect, at step 624 of optimized solution process using simulated annealing 604, a processor performing optimal solution determiner 116 performs operations to determine whether to accept the solution (e.g., the sample generated at step 622). In an aspect, this determination is based, at least in part, on the acceptance probability for moving to the neighboring solution, as described with respect to equation (4), below. In an aspect, at step 624, if it is determined to accept the solution (“YES” branch), optimized solution process using simulated annealing 604 continues at step 626. In an aspect, at step 624, if it is determined to not accept the solution (“NO” branch) optimized solution process using simulated annealing 604 continues at step 622 to generate a new sample based on the current sample.

In an aspect, at step 626 of optimized solution process using simulated annealing 604, a processor performing optimal solution determiner 116 performs operations to update values of the solution using simulated annealing, as described below in connection with step 810 of flow diagram 800. In an aspect, simulated annealing is performed according to an annealing schedule that governs how a parameter (e.g., a temperature parameter) decreases over time where the parameter decreases at each iteration of simulated annealing. In an aspect, this decrease of the temperature parameter is described below, at step 628. In an aspect, after step 626, optimized solution process using simulated annealing 604 continues at step 628.

In an aspect, at step 628 of optimized solution process using simulated annealing 604, a processor performing optimal solution determiner 116 performs operations to adjust the temperature. As described above, in an aspect, simulated annealing is performed according to an annealing schedule that governs how a parameter (e.g., a temperature parameter) decreases over time where the parameter decreases at each iteration of simulated annealing. Step 626 and step 628 of optimized solution process using simulated annealing 604 are discussed in more detail in connection with step 810 of flow diagram 800. In an aspect, after step 628, optimized solution process using simulated annealing 604 continues at step 630.

In an aspect, at step 630 of optimized solution process using simulated annealing 604, a processor performing optimal solution determiner 116 performs operations to determine whether a stop criteria has been reached (e.g., whether or not to terminate optimized solution process using simulated annealing 604). In an aspect, this stop criteria (also referred to herein as a termination criteria) is to stop after a determined number of iterations of optimized solution process using simulated annealing 604 have been performed. In an aspect, this stop criteria is to stop when a termination criteria has been met such as the solution reaching a local or global minimum. In an aspect, at step 630, if it is determined that a stop criteria has been reached (“YES” branch), optimized solution process using simulated annealing 604 continues at step 632. In an aspect, at step 630, if it is determined that a stop criteria has not been reached (“NO” branch), optimized solution process using simulated annealing 604 continues at step 622 to generate a new sample based on the current sample. In an aspect, after step 630, the process illustrated in flow diagram 600 ends at step 632. In an aspect, not shown in FIG. 6, after step 630, the process illustrated in flow diagram 600 continues at step 620, to generate solution bundles for GPUs or at step 622 to generate new samples.

In some embodiments, the steps of the method illustrated in flow diagram 600 can be performed in a different order than that illustrated in FIG. 6 when, for example, the results of one steps do not rely on the results of a previous steps. In some embodiments, the steps of the method illustrated in flow diagram 600 can be performed concurrently or in parallel by a plurality of threads operating on a computing system such as that illustrated in connection with FIG. 1. In some embodiments, a plurality of instances of initial solution process using genetic algorithm 602 can be performed concurrently or in parallel by a plurality of threads to produce multiple instances of solution bundle 618 (e.g., different solution bundles using different genetic operations). In some embodiments, a plurality of instances of optimal solution process using simulated annealing 604 can be performed concurrently or in parallel by a plurality of threads to analyze multiple instances of solution bundle 618 to generate one or more optimal solutions to the optimization problem, as described herein.

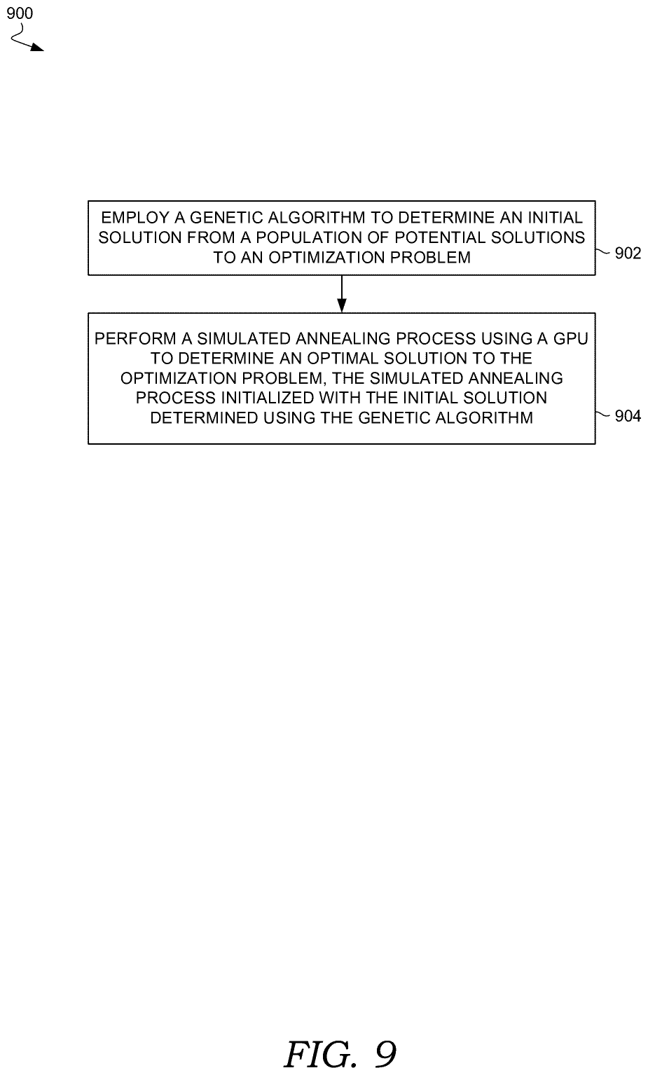

FIG. 7 and FIG. 8 provide example processes or methods that can be performed by initial solution determiner 114 and optimal solution determiner 116, respectively, when employing solver 112 for determining an optimal solution to an optimization problem using GPUs 108. FIG. 9 provides an example process or method that combines the example processes of FIG. 7 and FIG. 8 to generate a solution to an optimization problem. The figures illustrating these methods are intended to provide on illustrated example of the technology, and other processes and/or methods will be realized.

FIG. 7 is a flow diagram 700 an example method for performing a genetic algorithm phase to generate an initial solution to an optimization problem, in accordance with an aspect described herein. In an aspect, the process illustrated in flow diagram 700 is performed using solver 112 to determine an initial solution to an optimization problem using GPUs 108. Accordingly, in this example, initial solution determiner 114 can perform steps 702 through 714 of the flow diagram 700 illustrated in FIG. 7 to determine an initial solution, as described herein. As may be contemplated, this figure is intended to provide on illustrated example of the technology described herein and other processes and/or methods may be realized. Each step the process illustrated in flow diagram 700 can comprise a computing process performed using any combination of hardware, firmware, or software. For instance, various functions can be carried out by a processor executing instructions stored in memory. The process illustrated in flow diagram 700 can also be embodied as computer-usable instructions stored on computer storage media. The process illustrated in flow diagram 700 can be provided by a standalone application, a service or hosted service (standalone or in combination with another hosted service), or a plug-in to another product, to name a few possibilities. The process illustrated in flow diagram 700 can be implemented in whole or in part by components of operating environment 100, such as initial solution determiner 114 of solver 112, among other components or functions not illustrated.

In an aspect, at step 702 of the process illustrated in flow diagram 700, a processor performs operations to initialize a population of potential solutions (chromosomes) with binary strings. For example, let each chromosome be represented as a binary vector:

$$x = ( {x}_{1} , {x}_{2} , … , {x}_{n} ) , where {x}_{i} ∈ \{ 0 , 1 \} \qquad ( 1 )$$

Where x is a binary vector. In an aspect, each chromosome here is a binary vector such as samples 202 illustrated in FIG. 2. In an aspect, each chromosome or binary string is initialized with random or pseudorandom values, as described herein. In an aspect, after step 702, the process illustrated in flow diagram 700 continues at step 704.

In an aspect, at step 702 of the process illustrated in flow diagram 700, a processor performs operations to define a fitness function to evaluate the quality of each chromosome. For example, f(x) is an objective function value associated with chromosome x, defined in equation (1), such that:

$$f ( x ) = {\sum }_{i} {\sum }_{j} {Q}_{ij} {x}_{i} {x}_{j} \qquad ( 2 )$$

Where, xᵢ and xⱼ are bits of binary vector x and Qᵢⱼ is a real-valued upper-triangular matrix whose entries Qᵢⱼ define a weight for each pair of indices i,j∈{1, . . . , n} within the binary vector. Accordingly, the weight Qᵢⱼ is added to the sum if both xᵢ and xⱼ have a value equal to 1 and not added when either of them has a value equal to 0. Where i equals j, the weight Qui (e.g., the weight along the diagonal of the matrix) is added when xᵢ has a value equal to 1. In an aspect, after step 704, the process illustrated in flow diagram 700 continues at step 706.

In an aspect, at step 706 of the process illustrated in flow diagram 700, a processor performs operations to perform selection to choose parents for crossover based on their fitness values. Various selection methods, such as roulette wheel selection, tournament selection, etc., can be used to perform selection. As used herein, roulette wheel selection is a selection method where individuals from the population are chosen based on their fitness, where an individual with a higher fitness has a larger “slice” of a metaphorical roulette wheel so that the more fit individuals have a higher probability of being randomly selected (e.g., when the metaphorical wheel is spun) as parents for crossover, as described above. As used herein, tournament selection is a selection method where individuals from the population are chosen based on their fitness, where randomly selected individuals are paired off in a metaphorical tournament and the winner of the pairing (the individual with the with a higher fitness level) advances to the next round and the winner of the tournament is selected as a parent for crossover, as described above. In an aspect, other selection methods can be used including, but not limited to, rank selection, steady-state selection, elitist selection, Boltzmann selection, etc. In an aspect, after step 706, the process illustrated in flow diagram 700 continues at step 708.

In an aspect, at step 708 of the process illustrated in flow diagram 700, a processor performs operations to combine genetic material from selected parents to create new offspring (children). Various crossover methods such as single-point crossover, uniform crossover, etc., can be used to combine genetic material. As used herein, single-point crossover (also referred to as one-point crossover) is a recombination method where a point in each parent's vectors is chosen, typically at random, and bits in the vector after that point are swapped between the parents so that there are two offspring, each with some genetic information from both parents. As used herein, uniform crossover is is a recombination method where each bit is chosen from either parent with some probability where each bit is treated separately. In an aspect, other methods can be used including, but not limited to, two-point and k-point crossover, where two or more bits are chosen as endpoints of recombination segments within the chromosome. In some aspects, other methods of crossover or recombination such as discrete recombination or intermediate recombination may be used to combine genetic material. In an aspect, after step 708, the process illustrated in flow diagram 700 continues at step 710.

In an aspect, at step 710 of the process illustrated in flow diagram 700, a processor performs operations to apply mutation to introduce random variations in the offspring's genetic material. This helps maintain diversity in the population and avoid premature convergence. In an aspect, is the process of randomly swapping individual bits of a binary vector (or chromosome) so that, for example, a zero is changed to a one and a one os changed to a zero. In an aspect, after step 710, the process illustrated in flow diagram 700 continues at step 712.

In an aspect, at step 712 of the process illustrated in flow diagram 700, a processor performs operations to replace the old population with a new population of offspring. In an aspect, members of the old population are selected and replaced with members of the new population (e.g., the children). In an aspect, replacement optimizes the objective function of equation (2) and enhance population diversity, generating a better initial solution. In an aspect, after step 712, the process illustrated in flow diagram 700 continues at step 714.

In an aspect, at step 714 of the process illustrated in flow diagram 700, a processor performs operations to repeat one or more of the selection step (e.g., step 706), crossover step (e.g., step 708), mutation step (e.g., step 710), or replacement (e.g., step 712) steps for either a predefined number of generations or until a termination criterion is met (e.g., convergence, reaching a certain fitness threshold). In an aspect, a predefined number of steps (or generations) is chosen to execute the algorithm. In an aspect, a termination criteria is chosen so that, when the solution converges to an initial solution, the algorithm terminates. In an aspect, both of a predefined number of generations and a termination criterion are used so that the steps of the algorithm are repeated until either the convergence criteria has been met or the number of iterations have been performed. In an aspect, not shown in FIG. 7, a processor can perform operations to output the initial solution determined at step 714. In an aspect, after step 714, the process illustrated in flow diagram 700 terminates. In an aspect, not shown in FIG. 7, after step 714, the process illustrated in flow diagram 700 continues at step 702 to initialize a new population of potential solutions (chromosomes) with binary strings.

In some embodiments, the steps of the method illustrated in flow diagram 700 can be performed in a different order than that illustrated in FIG. 7 when, for example, the results of one steps do not rely on the results of a previous steps. In some embodiments, the steps of the method illustrated in flow diagram 700 can be performed concurrently or in parallel by a plurality of threads operating on a computing system such as that illustrated in connection with FIG. 1.

FIG. 8 is a flow diagram 800 illustrating an example method for performing a simulated annealing phase to generate an optimal solution to an optimization problem, in accordance with an aspect described herein. In an aspect, the process illustrated in flow diagram 800 is performed using solver 112 to determine an optimal solution to an optimization problem using GPUs 108. Accordingly, in this example, optimal solution determiner 116 can perform steps 802 through 812 of the flow diagram 800 illustrated in FIG. 8 to determine an optimal solution, as described herein. As may be contemplated, this figure is intended to provide on illustrated example of the technology described herein and other processes and/or methods may be realized. Each step the process illustrated in flow diagram 800 can comprise a computing process performed using any combination of hardware, firmware, or software. For instance, various functions can be carried out by a processor executing instructions stored in memory. The process illustrated in flow diagram 800 can also be embodied as computer-usable instructions stored on computer storage media. The process illustrated in flow diagram 800 can be provided by a standalone application, a service or hosted service (standalone or in combination with another hosted service), or a plug-in to another product, to name a few possibilities. The process illustrated in flow diagram 800 can be implemented in whole or in part by components of operating environment 100, such as optimal solution determiner 116 of solver 112, among other components or functions not illustrated.

In an aspect, at step 802 of the process illustrated in flow diagram 800, a processor performs operations to initialize the initial solution as the best solution found during the genetic algorithm phase (e.g., the result from the method illustrated in flow diagram 700). In an aspect, after step 802, the process illustrated in flow diagram 800 continues at step 804.

In an aspect, at step 804 of the process illustrated in flow diagram 800, a processor performs operations to define the objective function for the optimization problem. An example of an objective function in QUBO from is:

$$Q ( x ) = {\sum }_{i} {\sum }_{j} {Q}_{ij} {x}_{i} {x}_{j} \qquad ( 3 )$$

Where, xᵢ and xⱼ are bits of binary vector x and Qᵢⱼ is a real-valued upper-triangular matrix whose entries Qᵢⱼ define a weight for each pair of indices i,j∈{1, . . . , n} within the binary vector, as described above. In an aspect, after step 804, the process illustrated in flow diagram 800 continues at step 806.

In an aspect, at step 806 of the process illustrated in flow diagram 800, a processor performs operations to generate a neighboring solution by flipping the value of one or more randomly selected bits in the initial solution. In an aspect, the simulated annealing process performs a single-flip operation that flips a single bit within a binary variable vector. In an aspect, the simulated annealing process performs a multi-flip operation that flips multiple bits within a binary variable vector. In some aspects, the simulated annealing process includes a tabu search technique, the tabu search technique prohibiting flipping of a previously flipped bit for a determined number of iterations (e.g., a bit, once flipped, cannot be flipped back until a certain number of iterations have passed). In an aspect, after step 806, the process illustrated in flow diagram 800 continues at step 808.

In an aspect, at step 808 of the process illustrated in flow diagram 800, a processor performs operations to calculate the acceptance probability for moving to the neighboring solution. One example of an acceptance probability is:

$$P ( accept ) = exp ( - \frac{Δ E}{T} ) \qquad ( 4 )$$

Where P (accept) is the acceptance probability, ΔE is the change from a first state to a new state, and T is a temperature parameter. In an aspect, states with a smaller energy are preferable to states with a greater energy so that a simulated annealing method can avoid local minima that are worse (higher energy) than a global minima. In an aspect, after step 808, the process illustrated in flow diagram 800 continues at step 810.

In an aspect, at step 810 of the process illustrated in flow diagram 800, a processor performs operations to generate an annealing schedule which governs how the temperature parameter T decreases over time. One example of an annealing schedule is exponential annealing, where the temperature decreases at each iteration according to a cooling schedule. Exponential annealing is expressed as:

$$T ( iteration ) = {T}_{initial} * {α}^{iteration} \qquad ( 5 )$$

Where iteration is the iteration number, Tᵢₙᵢₜᵢₐₗ is an initial value for the temperature and a is a parameter that defines the annealing schedule (e.g., the rate of cooling). In an aspect, after step 810, the process illustrated in flow diagram 800 continues at step 812.

In an aspect, at step 812 of the process illustrated in flow diagram 800, a processor performs operations that continue the simulated annealing process for a specified number of iterations (e.g., steps 806-810) or until a termination condition is met. In an aspect, a predefined number of iterations is chosen to execute the steps of the algorithm. In an aspect, a termination condition is chosen so that, when the solution converges to an optimal solution, the algorithm terminates. In an aspect, both of a predefined number of iterations and a termination condition are used so that the steps of the algorithm are repeated until either the termination condition has been met or the number of iterations have been performed. In an aspect, not shown in FIG. 8, a processor can perform operations to output the optimal solution determined at step 812. In an aspect, after step 812, the process illustrated in flow diagram 800 terminates. In an aspect, not shown in FIG. 8, after step 812, the process illustrated in flow diagram 800 continues at step 802 to initialize a new solution as the best solution found during the genetic algorithm phase.

In some embodiments, the steps of the method illustrated in flow diagram 800 can be performed in a different order than that illustrated in FIG. 8 when, for example, the results of one steps do not rely on the results of a previous steps. In some embodiments, the steps of the method illustrated in flow diagram 800 can be performed concurrently or in parallel by a plurality of threads operating on a computing system such as that illustrated in connection with FIG. 1.

FIG. 9 is a flow diagram 900 illustrating an example method for combining a genetic algorithm phase and a simulated annealing phase to generate a solution to an optimization problem, in accordance with an aspect described herein. Each step of the process illustrated in flow diagram 900 can comprise a computing process performed using any combination of hardware, firmware, or software. For instance, various functions can be carried out by a processor executing instructions stored in memory. The process illustrated in flow diagram 900 can also be embodied as computer-usable instructions stored on computer storage media. The process illustrated in flow diagram 900 can be provided by a standalone application, a service or hosted service (standalone or in combination with another hosted service), or a plug-in to another product, to name a few possibilities. The process illustrated in flow diagram 900 can be implemented in whole or in part by components of operating environment 100, such as by initial solution determiner 114 and optimal solution determiner 116 of solver 112, among other components or functions not illustrated.

In an aspect, at step 902 of the process illustrated in flow diagram 900, a processor performs operations to employ a genetic algorithm to determine an initial solution from a population of potential solutions for an optimization problem. In an aspect, step 902 of the process illustrated in flow diagram 900 is performed using one or more steps of initial solution process using genetic algorithm 602, described at least in connection with FIG. 6. In an aspect, step 902 of the process illustrated in flow diagram 900 is performed using one or more steps of the process illustrated in flow diagram 700, described at least in connection with FIG. 7. In an aspect, the genetic algorithm employs an island model configured to introduce diversity in the potential solutions during determination of the initial solution. In an aspect, the initial solution determined by the genetic algorithm comprises a plurality of solution bundles, and each solution bundle comprises variable vectors and energy levels corresponding to each variable vector. In an aspect, each of the potential solutions is represented as a binary variable vector. In an aspect, the optimization problem is formulated in a QUBO (quadratic unconstrained binary optimization) form, as described above in equation (3). In an aspect, after step 902, the process illustrated in flow diagram 900 continues at step 904.

In an aspect, at step 904 of the process illustrated in flow diagram 900, a processor performs operations to perform a simulated annealing process using a GPU architecture to determine an optimal solution to the optimization problem. In an aspect, the simulated annealing process is initialized with the initial solution determined using the genetic algorithm at step 902. In an aspect, step 904 of the process illustrated in flow diagram 900 is performed using one or more steps of optimal solution process using simulated annealing 604, described at least in connection with FIG. 6. In an aspect, step 904 of the process illustrated in flow diagram 900 is performed using one or more steps of the process illustrated in flow diagram 800, described at least in connection with FIG. 8. In an aspect, the simulated annealing process performs a single-flip operation that flips a single bit within a binary variable vector. In another aspect, the simulated annealing process performs a multi-flip operation that flips multiple bits within a binary variable vector. In some aspects, the simulated annealing process includes a tabu search technique, the tabu search technique prohibiting flipping of a previously flipped bit for a determined number of iterations. In an aspect, a teacher-student technique is employed during the simulated annealing process to explore solution space between the solution bundles. The student-teacher technique may include merging the solution bundles into a unified student bundle, and executing a parallel processing technique on the unified student bundle using the genetic algorithm. In an aspect, not shown in FIG. 9, a processor can perform operations to output the optimal solution determined at step 904. In an aspect, after step 904, the process illustrated in flow diagram 900 terminates. In an aspect, not shown in FIG. 9, after step 904, the process illustrated in flow diagram 900 continues at step 902 to employ a genetic algorithm to determine an initial solution from a population of potential solutions to an optimization problem.

In some embodiments, the steps of the method illustrated in flow diagram 900 can be performed in a different order than that illustrated in FIG. 9 when, for example, the results of one steps do not rely on the results of a previous steps. In some embodiments, the steps of the method illustrated in flow diagram 900 can be performed concurrently or in parallel by a plurality of threads operating on a computing system such as that illustrated in connection with FIG. 1.

Having described an overview of some embodiments of the present technology, an example computing environment in which embodiments of the present technology may be implemented is described below in order to provide a general context for various aspects of the present technology. Referring now to FIG. 10 in particular, an example operating environment for implementing embodiments of the present technology is shown and designated generally as computing device 1000. Computing device 1000 is but one example of a suitable computing environment and is not intended to suggest any limitation as to the scope of use or functionality of the technology. Computing device 1000 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1002, which directly or indirectly couples the following devices: memory 1004, one or more processors 1006, one or more presentation components 1008, input/output (I/O) ports 1010, input/output components 1012, and illustrative power supply 1014. Bus 1002 represents what may be one or more buses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 10 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 10 and with reference to “computing device.”

Computing device 1000 typically includes a variety of computer-readable media. Computer-readable media can be any available media that can be accessed by computing device 1000 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1000. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1004 includes computer-storage media in the form of volatile or non-volatile memory. The memory may be removable, non-removable, or a combination thereof. Example hardware devices include solid-state memory, hard drives, optical-disc drives, etc. Computing device 1000 includes one or more processors that read data from various entities, such as memory 1004 or I/O components 1012. Presentation component(s) 1008 presents data indications to a user or other device. Example presentation components include a display device, speaker, printing component, vibrating component, etc.

I/O ports 1010 allow computing device 1000 to be logically coupled to other devices, including I/O components 1012, some of which may be built in. Illustrative components include a microphone, joystick, game pad, satellite dish, scanner, printer, wireless device, etc. The I/O components 1012 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1000. Computing device 1000 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1000 may be equipped with accelerometers or gyroscopes that enable detection of motion. The output of the accelerometers or gyroscopes may be provided to the display of computing device 1000 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. In this regard, functional components of FIG. 1 can manage resources and provide the described functionality. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of 112, among other functions, may be performed by server 102, computing device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving,” or “transmitting,” as facilitated by software or hardware-based buses, receivers, or transmitters” using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

An optimal solution, as described herein is intended to be the most favorable solution derived from a set of potential solutions generated within the constraints of available processing power and time. This solution minimizes or maximizes the defined objective(s) based on the data and algorithms employed during the computational process. It represents the best solution among those explored, within the computational resources allocated, to solve the optimization problem and achieve the desired logistical outcome. While it may not represent the absolute best solution possible due to limitations in computational resources, data accuracy, or physical interferences, it stands as the most efficient or effective solution identified through the computational process undertaken for a given set of parameters.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

What is claimed is:

1. A computerized method comprising:
employing a genetic algorithm to determine an initial solution from a population of potential solutions for an optimization problem; and
performing a simulated annealing process using a GPU architecture to determine an optimal solution to the optimization problem, the simulated annealing process initialized with the initial solution determined using the genetic algorithm.

2. The method of claim 1, wherein the simulated annealing process performs a single-flip operation that flips a single bit within a binary variable vector.

3. The method of claim 1, wherein the simulated annealing process performs a multi-flip operation that flips multiple bits within a binary variable vector.

4. The method of claim 1, wherein the simulated annealing process includes a tabu search technique, the tabu search technique prohibiting flipping of a previously flipped bit.

5. The method of claim 1, wherein the genetic algorithm employs an island model configured to introduce diversity in the potential solutions during determination of the initial solution.

6. The method of claim 1, wherein the initial solution determined by the genetic algorithm comprises a plurality of solution bundles, each solution bundle comprising variable vectors and energy levels corresponding to each variable vector, and wherein a teacher-student technique is employed during the simulated annealing process to explore solution space between the solution bundles.

7. The method of claim 6, wherein the teacher-student technique comprises:
merging the solution bundles into a unified student bundle; and
executing a parallel processing technique on the unified student bundle using the genetic algorithm.

8. The method of claim 6, wherein each of the potential solutions is represented as a binary variable vector.

9. The method of claim 1, wherein the optimization problem is formulated in a QUBO (quadratic unconstrained binary optimization) form.

10. A computer system comprising:
at least one processor; and
one or more computer storage media storing computer readable instructions thereon that when executed by the at least one processor cause the at least one processor to perform operations comprising:
employing a genetic algorithm to determine an initial solution from a population of potential solutions for an optimization problem; and
performing a simulated annealing process using a GPU architecture to determine an optimal solution to the optimization problem, the simulated annealing process initialized with the initial solution determined using the genetic algorithm.

11. The computer system of claim 10, wherein the simulated annealing process performs a single-flip operation that flips a single bit within a binary variable vector.

12. The computer system of claim 10, wherein the simulated annealing process performs a multi-flip operation that flips multiple bits within a binary variable vector.

13. The computer system of claim 10, wherein the simulated annealing process includes a tabu search technique, the tabu search technique prohibiting flipping of a previously flipped bit for one or more iterations of the simulated annealing process.

14. The computer system of claim 10, wherein the genetic algorithm employs an island model configured to introduce diversity in the potential solutions during determination of the initial solution.

15. The computer system of claim 10, wherein the optimization problem is formulated in a QUBO (quadratic unconstrained binary optimization) form.

16. A computer storage medium storing computer readable instructions that, when executed by one or more computing devices, cause the computing devices to perform operations, the operations comprising:
employing a genetic algorithm to determine an initial solution from a population of potential solutions for an optimization problem; and
performing a simulated annealing process using a GPU architecture to determine an optimal solution to the optimization problem, the simulated annealing process initialized with the initial solution determined using the genetic algorithm.

17. The computer storage medium of claim 16, wherein the simulated annealing process performs bit-flipping operation that flips one or more bits within a binary variable vector.

18. The computer storage medium of claim 16, wherein the simulated annealing process includes a tabu search technique, the tabu search technique prohibiting flipping of a previously flipped bit.

19. The computer storage medium of claim 16, wherein the initial solution determined by the genetic algorithm comprises a plurality of solution bundles, each solution bundle comprising variable vectors and energy levels corresponding to each variable vector, and wherein a teacher-student technique is employed during the simulated annealing process to explore solution space between the solution bundles.

20. The computer storage medium of claim 16, wherein the optimization problem is formulated in a QUBO (quadratic unconstrained binary optimization) form.
